(19) United States
(12) Patent Application Publication
(10) Pub. No.: US 2015/0293590 A1
(43) Pub. Date: Oct. 15, 2015

(54) Method, Apparatus, And Computer Program Product For Haptically Providing Information Via A Wearable Device

(71) Applicant: Nokia Corporation, Espoo (FI)

(72) Inventors: Arto Juhani Lehtiniemi, Lempaala (FI); Jussi Artturi Leppanen, Tampere (FI); Antti Johannes Eronen, Tampere (FI); Miikka Tapani Vilermo, Siuro (FI)

(73) Assignee: Nokia Corporation, Espoo (FI)

(21) Appl. No.: 14/251,130

(22) Filed: Apr. 11, 2014

(51) Int. Cl. G06F 3/01

(52) U.S. Cl. CPC G06F 3/016; G06F 3/017

(57) ABSTRACT

A method, apparatus and computer program product are provided for haptically provided information via a wearable device, and controlling a user device, such as with a gesture input. The user device may be the wearable device, or another user device in close proximity to the wearable device. The wearable device may be beneficial to a user while exercising, such as to control music playback or workout programs. Haptically provided information may be provided via the wearable device to provide feedback in response to the gesture input, and/or to facilitate user provision of the gesture input. The haptically provided information may convey a beat or rhythm of the content or characteristics of a media file, and the gesture input may indicate selection of the media file. An operation to be performed on the user device may be determined based on the selected data item and/or type of gesture input.

### TECHNOLOGICAL FIELD

An example embodiment of the present invention relates generally to user interfaces, and more particularly, to a method, apparatus and computer program product for causing information to be haptically provided via a wearable device.

### BACKGROUND

Many runners and other athletes use electronic devices during their activities to listen to music, control workout programs, and/or the like. Small display screens and user interface controls can make it difficult for a user to see the display, and/or to make the intended selections, particularly while running, jumping, or performing any other kind of movement. Smart watches designed to provide electronic capabilities via a small, lightweight wearable device can be uncomfortable to use. It may be difficult for a user to view the display of a watch, and may require the user look downward at the user's wrist, distracting the user from the activity. A user of a watch during exercise may therefore risk tripping, falling and/or the like. It is also difficult for a user to precisely make a selection on a watch being worn on one wrist by having to cross the other hand in front of the body, and make a selection of a small button or other control while the user is running. Often times, a user may mistakenly make the wrong selection, or make an unintended selection due to the movement.

Devices slightly larger than a wrist watch may be worn by strapping the device elsewhere on the user's body, such as high on the user's arm. To control the device, however, the user must release the device from the strap and hold the device with one hand while providing inputs with the other hand. In this example, the device is also difficult to control and to view, and the user even risks dropping and damaging the device.

### BRIEF SUMMARY

A method, apparatus, and computer program product are therefore provided for causing information to be haptically provided. Certain example embodiments described herein may allow a user to provide input to a wearable device and perceive haptically provided information via the wearable device, without having to look at the wearable device. For example, haptically provided information may provide a preview of a data item, and a user may select the data item with a gesture input via the wearable device. The wearable device may be configured to control other devices as described herein.

A method is provided, including causing information to be haptically provided via a wearable device so as to provide a preview of a data item, receiving an indication of a selection of the data item provided via the wearable device, with a processor, determining an operation to be performed on a user device based on the indication of the selected data item, and causing the operation to be performed by the user device.

In an example embodiment, the causing the information to be haptically provided comprises causing a vibration corresponding to the content or a characteristic of the data item to be haptically provided. The indication of the selection of the data item may be provided via a gesture input to the wearable device. The indication of the selection may be provided based on a movement of the wearable device relative to the user's body. The operation to be performed by the user device of an example embodiment is further based on an activity being performed by the user. In an example embodiment in which the data item is a media file, the operation comprises initiating playing the selected media file. The operation to be performed by the user device of an example embodiment is further based on a type of gesture input.

In an example embodiment, the method further includes causing provision of another data item via the wearable device while the information is haptically provided, wherein the provision of the another data item is undisturbed.

In another example embodiment, an apparatus is provided that includes at least one processor and at least one memory including computer program code with the at least one memory and the computer program code configured to, with the processor, cause the apparatus to at least perform causing information to be haptically provided via a wearable device so as to provide a preview of a data item, receiving an indication of a selection of the data item provided via the wearable device, determining an operation to be performed on a user device based on the indication of the selected data item, and causing the operation to be performed by the user device.

In a further example embodiment, a computer program product is provided that comprises at least one non-transitory computer-readable storage medium having computer-executable program code instructions stored therein with the computer-executable program code instructions comprising program code instructions for causing information to be haptically provided via a wearable device so as to provide a preview of a data item, receiving an indication of a selection of the data item provided via the wearable device, determining an operation to be performed on a user device based on the indication of the selected data item, and causing the operation to be performed by the user device.

In yet another example embodiment, an apparatus is provided that includes means for causing information to be haptically provided via a wearable device so as to provide a preview of a data item, means for receiving an indication of a selection of the data item provided via the wearable device, means for determining an operation to be performed on a user device based on the indication of the selected data item, and means for causing the operation to be performed by the user device.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a schematic diagram of a wearable device according to an example embodiment;

FIG. 2 is a block diagram of a system for haptically providing information via a wearable device according to an example embodiment;

FIG. 3 is a schematic diagram of an apparatus for haptically providing information via a wearable device according to an example embodiment;

FIG. 4 is a flowchart of operations for haptically providing information via a wearable device according to an example embodiment; and

FIGS. 5A-5D are illustrations demonstrating gesture inputs to a wearable device according to some example embodiments.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

FIG. 1 is a schematic diagram of a wearable device 100 which may be an electronic device configured to be secured on or around a part of a user's body. For example, the wearable device 100 may be a wristband, armband, ankle band, necklace, and/or the like.

As described in further detail herein, the wearable device 100 may be configured to haptically provide information. Information may be provided haptically by causing vibrations, other movements and/or physical modifications of a surface created by actuators or components of the wearable device 100. For example, electroactive polymers (EAPs) may be actuated to physically cause a change of size and/or shape that may be perceived by a user. In an example embodiment, other actuators made of piezoelectric material may be actuated to provide haptically provided information. The haptically provided information may enable a user to preview information related to a data item. Information related to various types of data items may be previewed, such as information related to media items, such as a media file, for example. As such, subsequent discussion of a media file is provided by way of example, but not of limitation, as an example embodiment applies to a variety of different types of data items in addition to or instead of a media file. In regards to a media item, e.g., a media file, however, information regarding a media item, such as a next song for music playback, may be previewed without stopping current media being presented, or a current song being played via headphones. In this regard, “previewing” a song or media file with the use of haptically provided information may include haptically providing information such that the user may distinguish or otherwise identify one or more characteristics of the media file in preparation for making a selection. For example, a preview may comprise a vibration to the beat or rhythm of a song.

The haptically provided information may also provide feedback, such as responses to and/or confirmation of gesture inputs. The haptically provided information may enable a user to receive information via the wearable device 100 without having to look at a display screen of the wearable device 100. Therefore, the wearable device 100 may provide for convenient and efficient user experience while exercising.

According to an example embodiment, a preview of information related to a data item, such a media item, may include a haptic preview of the information related to the media item. A haptic preview may include haptic feedback, such as tactile feedback, based on a characteristic of the media item. According to an example embodiment, haptic feedback, such as tactile feedback, is based on at least a portion of the content of the media item. According to an example embodiment, haptic feedback, such as tactile feedback, corresponds to at least a portion of the content of a media file.

As described in further detail herein, the wearable device 100 may be configured to receive a gesture input. A gesture input may include a touch gesture input (e.g., a tap, a double tap, a swipe or a flick gesture), a motion gesture input (e.g., tilting, rotating or shaking a device), a hover gesture input (e.g., a gesture in close proximity to a device without touching the device) or a combination thereof. According to an example embodiment described herein, a gesture input may be provided without the user having to look at the wearable device. In this regard, a gesture inputs may be provided by touching or moving the wearable device 100. In an example embodiment, a gesture input may include touching the wearable device 100 with a touching object, such as a user's finger and/or hand. It will be appreciated that any reference to a finger and/or hand touching, grasping, and/or moving the wearable device 100, is not intended to limit the scope in any way, and that any object, such as a stylus, used for touching or moving the wearable device 100 may be used.

In an example embodiment, the gesture input may comprise a hover input. Additionally or alternatively, a gesture input may comprise a pumping gesture. In an example embodiment, a pumping gesture comprises a repetitive movement of the wearable device 100 relative to the user's body (e.g., movement of the wearable device back and forth on a user's wrist), or a repetitive movement of the user's body part that carries the wearable device (e.g., repetitive movement of the user's arm or wrist that carries the wearable device) relative to the rest of the user's body.

The wearable device 100 may include outer sensors 102, inner sensors 104, display(s) 108, and controls 110. In this regard, the outer sensors 102 may face outwardly away from the user's body part, e.g., the user's arm or wrist, upon which the wearable device is mounted. Conversely, the inner sensor 104 may face inwardly toward the user's body part, e.g., the user's arm or wrist, upon which the wearable device is mounted. The outer sensors 102 and/or inner sensors 104 may comprise touch-sensitive sensors capable of detecting touch inputs to the wearable device and/or movement of the wearable device 100 relative to a user's body. In an example embodiment, the outer sensors 102 and/or inner sensors 104 may comprise graphene configured to sense touch. Graphene present on the inner portions of the wearable device 100 of an example embodiment may even conduct energy from a user to power the wearable device 100. In an example embodiment, the wearable device 100 may additionally or alternatively be powered by a battery (not shown).

The display 108 may be a flexible display such as to allow for easy flexing of the wearable device 100 around a user's body, such as the user's wrist, for example. In an example embodiment, numerous displays 108 may be present, or no displays may be present. A display 108 of an example embodiment is a touch screen display for providing input by touch to the wearable device 100.

The controls 110 may be used for powering on and/or off the wearable device 100, for example, and/or to provide other inputs to the wearable device 100. In an example embodiment, the wearable device 100 may comprise an accelerometer (not shown) configured to detect movement and acceleration of the wearable device 100.

The wearable device 100 may further include any number of haptic actuators for providing information haptically (e.g., vibrations, forces, and/or motions). Furthermore, additional user interface components of the wearable device 100 may be present, such as a speaker, hover sensor(s), display backlight(s), LED (light emitting-diode) indicator lights, and/or the like.

While referred to herein as a wearable device, the wearable device 100 may be any watch (e.g., smart watch), wristband device, digital bracelet, digital wristband, digital necklace, digital ankle bracelet, a head mounted display or similar device that may be worn on the body or body part of a user. An example embodiment described herein may be implemented with different types of devices, including some non-wearable devices.

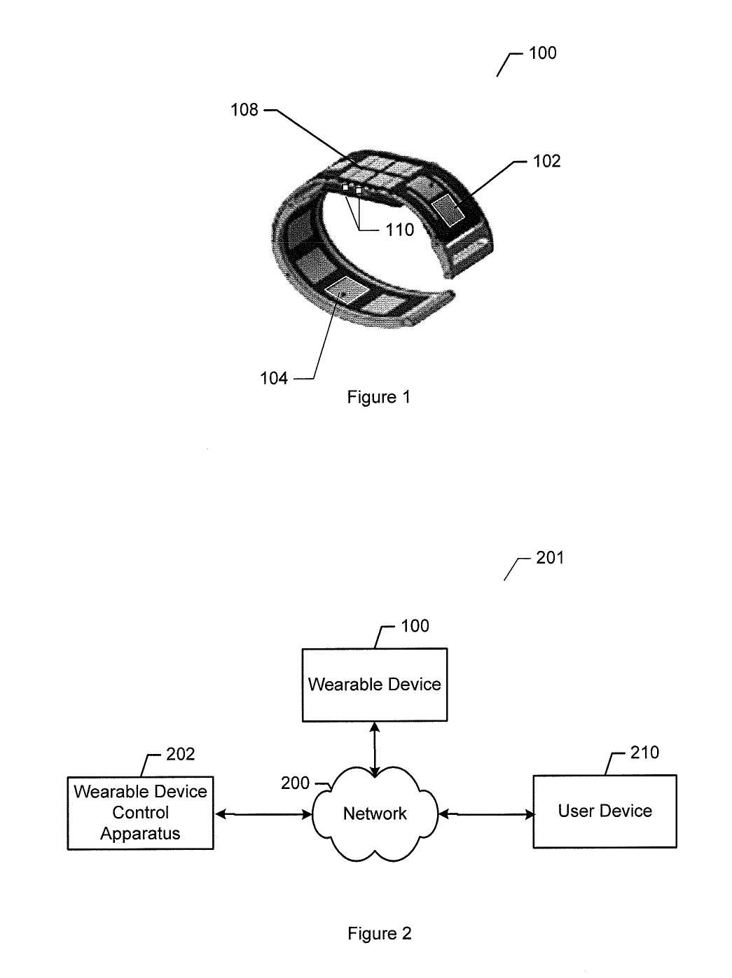

FIG. 2 is a block diagram of a system 201 for providing control of a user device with gesture input to a wearable device 100 according to an example embodiment. In an example embodiment, a user may perceive haptically provided information via the wearable device 100 and provide gesture inputs via the wearable device 100. The user interactions with the wearable device 100 may control certain operations of the wearable device 100, and/or, in an example embodiment, may control operations, such as playback of music, on another user device 210. In an example embodiment, the wearable device 100 may include or otherwise be in communication with a wearable device control apparatus 202 for interpreting the gesture inputs, and/or directing the wearable device 100 to haptically provide information.

The wearable device 100 may therefore be configured to communicate over network 200 with the wearable device control apparatus 202 and/or the user device 210. In this regard, the wearable device 100 may be implemented with ultra-low power miniaturized electronic components capable of communicating with the wearable device control apparatus 202 and/or the user device 210 such as via a Bluetooth® low energy network and/or other wireless personal area network (WPAN).

In general, the wearable device control apparatus 202 may be configured to receive indications of gesture inputs provided to the wearable device 100, identify operations to be performed based on the gesture input, and/or direct the wearable device 100 to haptically provide information to the user. In some example, the wearable device control apparatus 202 may be implemented on or by the wearable device 100. In an alternative embodiment, the wearable device control apparatus 202 may be configured to communicate with the wearable device 100 over network 200. In this regard, the wearable device control apparatus 202 may be implemented as a remote computing device (e.g., server), and/or a mobile device, such as one in close proximity to or in the possession of the user of the wearable device 100 (e.g., user device 210).

In general, the user device 210 may be configured to perform operations based on the gesture inputs to the wearable device 100. According to an example embodiment, the user device 210 may be implemented on a listening device, such as Bluetooth® headphones, and/or other mobile device that may be in the possession of or located proximate to the user of the wearable device 100. In an example embodiment, the user device 210 may be directed by the wearable device control apparatus 202 such as via network 200. In an example embodiment, such as those in which the wearable device control apparatus 202 is implemented on the wearable device 100, the user device 210 may be directed at least partially by the wearable device 100.

In an example embodiment, the user device 210 may be a separate device from the wearable device 100. Alternatively, the user device 210 may be embodied by the wearable device 100. For example, the wearable device 100 may be configured to play music via a speaker of the wearable device 100, and/or provide training programs via a display 108 and/or other user interface component of the wearable device 100. The music and the training programs may therefore be stored in memory of the wearable device 100 and/or may be accessible by the wearable device 100. In an example embodiment, the user device 210 is configured to play music, provide training programs, and/or the like, and may be controlled by gesture inputs provided to the wearable device 100, as described herein.

Network 200 may be embodied in a personal area network, local area network, the Internet, any other form of a network, or in any combination thereof, including proprietary private and semi-private networks and public networks, such as the Internet. The network 200 may comprise a wire line network, wireless network (e.g., a cellular network, wireless local area network (WLAN), WPAN, wireless wide area network).

In an example embodiment, the network 200 may include a variety of network configurations. For example, the wearable device 100 may communicate with the user device 210 via a WPAN, while the user device 210 may communicate with the wearable device control apparatus 202 via a WLAN. In such an embodiment, the wearable device 100 may communicate with a user device 210 (e.g., a mobile phone in the possession of the user of the wearable device 100). The user device 210 may be configured to communicate with the wearable device control apparatus 202, which may be implemented as a server or other remote commuting device.

As another example, a wearable device control apparatus 202 may communicate with user device 210 via a direct connection.

As mentioned above, in an example embodiment, wearable device control apparatus 202 and user device 210 may be implemented on the wearable device 100. Therefore, network 200 may be considered optional.

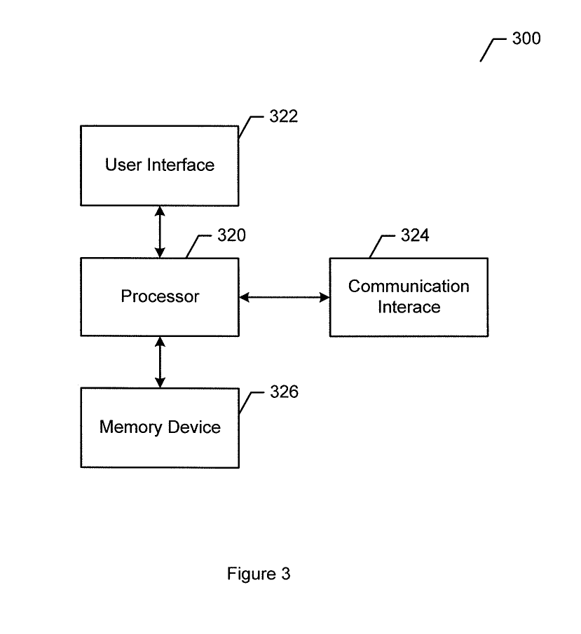

FIG. 3 is a schematic diagram of an apparatus 300 which may implement any of the wearable device 100, wearable device control apparatus 202, and/or the user device 210. Apparatus 300 may include a processor 320, memory device 326, user interface 322, and/or communication interface 324. In the context of at least the user device 210, apparatus 300 may be embodied by a wide variety of devices such as a mobile terminal, such as a personal digital assistant (PDA), a pager, a mobile telephone, a gaming device, a tablet computer, a smart phone, a video recorder, an audio/video player, a radio, a global positioning system (GPS) device, a navigation device, or any combination of the aforementioned, and other types of voice and text communications systems.

In an example embodiment, the processor 320 (and/or co-processors or any other processing circuitry assisting or otherwise associated with the processor 320) may be in communication with the memory device 326 via a bus for passing information among components of the apparatus 300. The memory device 326 may include, for example, one or more volatile and/or non-volatile memories. In other words, for example, the memory device 326 may be an electronic storage device (e.g., a computer readable storage medium) comprising gates configured to store data (e.g., bits) that may be retrievable by a machine (e.g., a computing device like the processor 320). The memory device 326 may be configured to store information, data, content, applications, instructions, or the like for enabling the apparatus to carry out various functions in accordance with an example embodiment of the present invention. For example, the memory device 326 could be configured to buffer input data for processing by the processor 320. Additionally or alternatively, the memory device 326 could be configured to store instructions for execution by the processor 320.

The apparatus 300 may, in an example embodiment, be embodied in various devices as described above. However, in an example embodiment, the apparatus 300 may be embodied as a chip or chip set. In other words, the apparatus 300 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 300 may therefore, in some cases, be configured to implement an example embodiment of the present invention on a single chip or as a single “system on a chip.” As such, in some cases, a chip or chipset may constitute means for performing one or more operations for providing the functionalities described herein.

The processor 320 may be embodied in a number of different ways. For example, the processor 320 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in an example embodiment, the processor 320 may include one or more processing cores configured to perform independently. A multi-core processor may enable multiprocessing within a single physical package. Additionally or alternatively, the processor 320 may include one or more processors configured in tandem via the bus to enable independent execution of instructions, pipelining and/or multithreading.

In an example embodiment, the processor 320 may be configured to execute instructions stored in the memory device 326 or otherwise accessible to the processor 320. Alternatively or additionally, the processor 320 may be configured to execute hard coded functionality. As such, whether configured by hardware or software methods, or by a combination thereof, the processor 320 may represent an entity (e.g., physically embodied in circuitry) capable of performing operations according to an example embodiment of the present invention while configured accordingly. Thus, for example, when the processor 320 is embodied as an ASIC, FPGA or the like, the processor 320 may be specifically configured hardware for conducting the operations described herein. Alternatively, as another example, when the processor 320 is embodied as an executor of software instructions, the instructions may specifically configure the processor 320 to perform the algorithms and/or operations described herein when the instructions are executed. However, in some cases, the processor 320 may be a processor of a specific device (e.g., a mobile terminal or network entity) configured to employ an example embodiment of the present invention by further configuration of the processor 320 by instructions for performing the algorithms and/or operations described herein. The processor 320 may include, among other things, a clock, an arithmetic logic unit (ALU) and logic gates configured to support operation of the processor 320.

Meanwhile, the communication interface 324 may be any means such as a device or circuitry embodied in either hardware or a combination of hardware and software that is configured to receive and/or transmit data from/to a network and/or any other device or module in communication with the wearable device control apparatus 202 such as between the wearable device 100 and the user device 210. In this regard, the communication interface 324 may include, for example, an antenna (or multiple antennas) and supporting hardware and/or software for enabling communications with a wireless communication network. Additionally or alternatively, the communication interface 324 may include the circuitry for interacting with the antennas) to cause transmission of signals via the antenna(s) or to handle receipt of signals received via the antenna(s). In some environments, the communication interface 324 may alternatively or also support wired communication. As such, for example, the communication interface 324 may include a communication modem and/or other hardware/software for supporting communication via cable, digital subscriber line (DSL), universal serial bus (USB) or other mechanisms.

In an example embodiment, the apparatus 300 may include a user interface 322 that may, in turn, be in communication with the processor 320 to receive an indication of, or relating to, a user input and/or to cause provision of an audible, visual, mechanical or other output to the user. As such, the user interface 322 may include, for example, a keyboard, a mouse, a joystick, a display, a touch screen(s), touch areas, soft keys, a microphone, a speaker, or other input/output mechanisms. In instances the apparatus 300 is embodied by a wearable device 100, the user interface 322 may comprise any of the outer sensors 102, inner sensors 104, display 108, controls 110 and/or haptic actuators.

Alternatively or additionally, the processor 320 may comprise user interface circuitry configured to control at least some functions of one or more user interface elements such as, for example, a speaker, ringer, microphone, display, and/or the like. The processor 320 and/or user interface circuitry comprising the processor 320 may be configured to control one or more functions of one or more user interface elements through computer program instructions (e.g., software and/or firmware) stored on a memory accessible to the processor 320 (e.g., memory device 326, and/or the like).

According to an example embodiment, communication interface 324 may be configured to communicate with a communication interface of another apparatus of system 201, either directly or over a network 200. Wearable device control apparatus 202 may, for example, be embodied as a server, remote computing device, and/or the like. In this regard, wearable device control apparatus 202 may comprise a direct connection, or connection via network 200, to wearable device 100. Wearable device 100 may there operate as a thin client for receiving user inputs and haptically providing information while the wearable device control apparatus 202 processes the inputs to control the wearable device 100 and/or user device 210, as described herein.

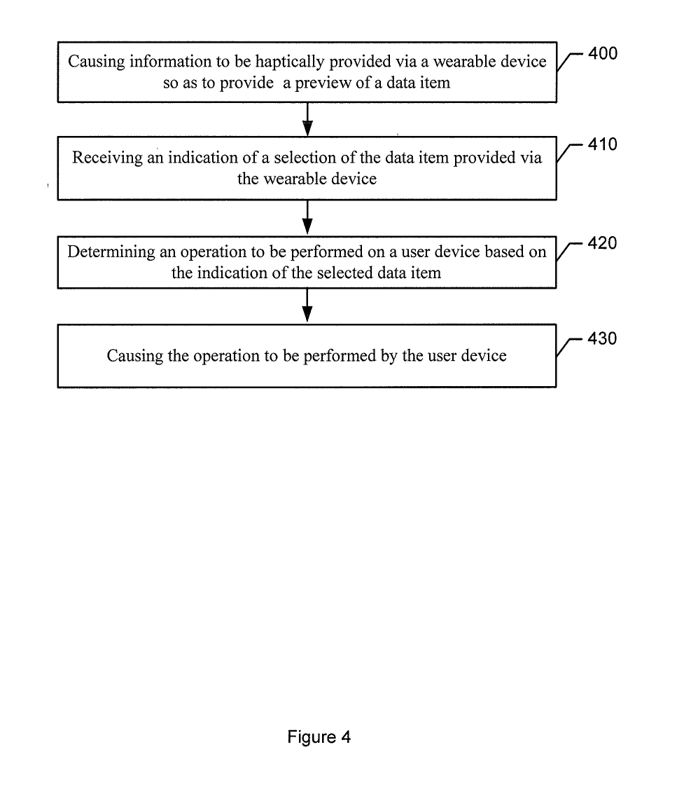

FIG. 4 is a flowchart of operations for providing control of a user device according to an example embodiment.

As shown by operation 400, the wearable device control apparatus 202 may include means, such as communication interface 324, user interface 322, processor 320, and/or the like, for causing information to be haptically provided via a wearable device so as to provide a preview of information relating to a data item, such as a media item, e.g., a media file. In an example embodiment, causing the information to be haptically provided comprises causing a vibration corresponding to the content or characteristics of the media file, such as to the beat or rhythm of the content or characteristics of the media file. Such haptically provided information may be provided via one or more haptic actuators on the wearable device 100 that may be actuated to produce a vibrating sensation on the user's body, for example.

In an example embodiment, the haptically provided information may indicate or convey an option of a menu. In an instance in which the menu provides a list of media files (e.g., audio files, workout program, or songs), the haptically provided information may comprise a preview that corresponds to a media file based on a recognized beat or onset sequence. The user may therefore feel the rhythm of a song to be better able to make a selection to suit the activity. The user may select a media file or other menu option, such as by providing a gesture input to the wearable device 100, as described in further detail below with respect to operation 410. Different media files (which may be stored on or accessed via user device 210, for example), may be circulated in a preview list (e.g., options menu). In this regard, the haptically provided information may comprise a pulse such that the beats of the songs are played and/or previewed with a short pulse and the down-beats with a stronger pulse. Providing a preview of a song or media file with the use of haptically provided information may enable the user to distinguish or otherwise identify characteristics of the media file in preparation for making a selection.

In an example embodiment, the wearable device control apparatus 202 may cause the wristband device 100 to “play” pulses on the onset times of the melody or a riff in the song. ‘du-du-duu—du-du-duduu—’ for “Smoke on the Water,” for example. While the user holds his hand static, the song preview may be provided. In an example embodiment, no actual audio will be played and the user may continue listening to a song already playing, such as with headphones and/or other user device 210 while previewing another song by perceiving the haptically provided information. A currently played media file may therefore continue to be provided or played, undisturbed by the haptically provided information.

In an example embodiment, the wearable device 100 may have more than one independent haptic actuator, and different actuators may convey different information and/or types of information. For example, one actuator may pulse in the rhythm of the beat and another actuator may pulse in the rhythm of the melody. The device may also choose to use an actuator close and/or closest to the user's thumb to pulse in the rhythm of the beat and to use an actuator close and/or closest to the user's index finger to pulse in the rhythm of the melody.

As another example embodiment, the haptically provided information may be associated with any content or characteristic of a media file. For example, the haptically provide information may coincide, or may be associated with any of a pitch, chroma, beat, tactus, tempo, bar, measure, downbeat, changes in loudness or timbre, harmonic changes and/or the like of a song, audio track, or other content of a media file. In this regard, the wearable device control apparatus 202 may be configured for measuring musical accentuation, performing period estimation of one or more pulses, finding the phases of the estimated pulses, choosing the metrical level corresponding to the tempo or some other metrical level of interest and/or detecting events and/or changes in music. Such changes may relate to changes in the loudness, changes in spectrum and/or changes in the pitch content of the signal. As an example, the wearable device control apparatus 202 may detect spectral change from the signal, calculate a novelty or an onset detection function from the signal, detect discrete onsets from the signal, and/or detect changes in pitch and/or harmonic content of the signal, for example, using chroma features. When performing the spectral change detection, various transforms or filter bank decompositions may be used, such as Fast Fourier Transform, multi rate filter banks, even fundamental frequency F0 estimators, and/or pitch salience estimators. As an example, accent detection may be performed by calculating the short-time energy of the signal over a set of frequency bands in short frames over the signal, and then calculating the difference, such as the Euclidean distance, between every two adjacent frames. Any portion of the song may be selected for analysis, such as a part identified to be the most representative of the overall song style, (e.g., the chorus of the song). The haptically provided information may be based on any of the above detected and/or estimated characteristics in a song.

The wearable device 100 may be triggered to haptically provide the information in various manners. For example, the wearable device 100 may be configured to recognize as the trigger a predefined user input, such as a predefined touch input, a predefined gesture, a predefined movement (e.g., sliding) of the wearable device relative to the portion of the user's body, e.g., the user's wrist, upon which the wearable device is worn, a predefined movement of the wearable device relative to a portion of the user's body other than that portion of the user's body upon which the wearable device is worn or the like. In response to the trigger, the wearable device 100 may haptically provide the information. The haptically provided information may convey an example tempo, or preview tempo, of the contents of the selected data item to the user. The user may adjust a tempo, for example, by rotating the wearable device 100. When a suitable tempo is found, songs and/or workout programs having a tempo similar to the selected tempo may be played and/or added to a playlist. Such an example embodiment allows a user to select a song or workout program based on a desired tempo. The data item, such as the media item, e.g., media file, about which the wearable device 10 haptically provides information may be identified in various manners. For example, a listing of one or more data items, e.g., a playlist, may have been previously identified or otherwise be active such that triggering the wearable device to haptically provide information may cause information to be haptically provided regarding the first or the current data item, e.g., media file, in the listing.

In an example embodiment, a workout program may be operative on the user device 210 and/or wearable device 100. Haptically provided information may therefore coincide with the workout program. For example, the haptically provided information may comprise vibrations to a desired beat depending on a workout. A user performing interval training may therefore experience haptically provided information (e.g., a perceived beat) that changes in speed, frequency, and/or the like, corresponding to a different interval speed or intensity, for example. As another example, haptically provided information may be provided to represent a running or biking cadence, and/or or target heart rate. Such haptically provided information may be provided via an options menu.

In an example embodiment, it will be appreciated that in addition to, or instead of providing information haptically, the wearable device 100 may provide the information or preview by sound, such as a beep or ringtone.

As shown by operation 410, the wearable device control apparatus 202 may include means, such as communication interface 324, user interface 322, processor 320, and/or the like, for receiving an indication of the data item, such as the media item, e.g., the media file, provided via the wearable device, such as wearable device 100. In an example embodiment, the indication of the selection of the data item, such as a media file, is provided via a gesture input to the wearable device 100.

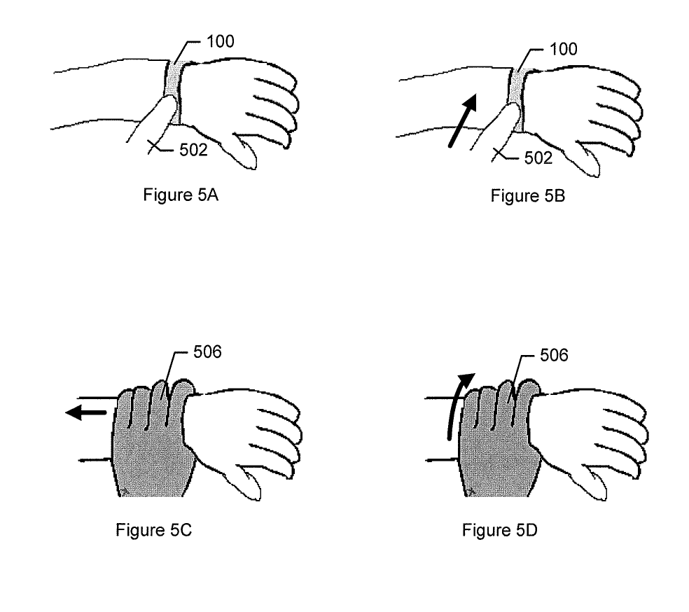

For example, the gesture input may comprise a touch, with at least one finger, such as with the user's other hand, to the wearable device 100. For example, as illustrated in FIG. 5A, a finger 502 touches the wearable device 100. The touch input may be interpreted by the wearable device control apparatus 202 as the gesture input. A touch screen display and/or outer sensor 102 (not shown in FIG. 5A), for example, may detect the gesture input.

In an example embodiment, the gesture input may comprise a movement of at least a user's finger over the wearable device 100. For example, as illustrated in FIG. 5B, the user's finger 502 touches the wearable device 100, and the user's finger is moved as indicated by the arrow, while in contact with the wearable device 100, over the wearable device 100. The finger 502 may be moved over a touch screen display or outer sensor 102, (not shown in FIG. 5B) so that the wearable device 100 may detect the gesture input. The directional arrow is provided merely as example and the direction of the movement, as in any of the displays of FIGS. 5B, 5C, and/or 5D, may be made in any direction. Based on the gesture input, such as with outer sensors 102, the wearable device control apparatus 202 may identify a direction of movement. A corresponding operation may be identified based on the direction, as described in further detail with respect to operation 420.

In an example embodiment, the movement of a user's finger or hand over or on the wearable device 100 may be detected in various manners, such as based on a sound created by the movement and based on the surface (such as on outer sensors 102) of the wearable device 100. In this regard, a sound generated may be considered an internal sound that may not be recognized by a user. For example, the surface may have tiny bumps with shallow edges facing one direction and steep edges facing another direction, such that a different type of sound is generated based on a direction of a sliding input or movement. In an instance a user slides a finger, hand, or other touching object over the wearable device 100 in one direction, a first type of sound is generated. In an instance in which the touching object is moved over the wearable device 100 in another direction, a second type of sound is generated. The wearable device 100 may detect the sound, such as with a microphone, and may therefore distinguish between gesture inputs comprising movements in different directions.

In an example embodiment, a user pulling a finger(s) along with the wearable device 100 may be recognized by a touch screen display (e.g., a swiping gesture along the display). In an example embodiment, a gesture input may be provided by a user's index finger and thumb touching the wearable device 100 and/or a pumping gesture.

In an example embodiment, the gesture input may comprise a movement of the wearable device 100 relative to a user's body. For example, FIG. 5C illustrates a user's hand touching or grasping the wearable device 100 (not visible in FIG. 5C). The user may then slide the wearable device 100, such as indicated by the arrow. In an example embodiment, the user may provide a pumping gesture of the wearable device 100 back and forth. The sliding and/or pumping may be detected, and corresponding operations may be identified by the wearable device control apparatus 202 as described in further detail herein.

Another example of a movement of the wearable device 100 relative to a user's body is illustrated with respect to FIG. 5D. In this example, as indicated by the arrow, the user rotates the hand gripping or holding the wearable device 100. The rotation and/or direction of the rotation may be detected by the wearable device 100 and interpreted by the wearable device control apparatus 202, as described herein.

In the above example embodiment in which the wearable device 100 is moved relative to the user's body, the movement may be detected in a variety of ways. In some example, inner sensors 104 may detect the movement of the wearable device 100 relative to the user's body or body part (e.g., wrist or arm), based on the friction created from the sliding or rubbing of the wearable device 100 against the body. As another example, optical sensors can be used to detect the movement. As similarly described above, a textured surface may cause a sound to be generated and detected by the wearable device 100.

In an example embodiment, the gesture input may comprise a motion of the body part wearing the wearable device 100. For example, a user may make a sudden pumping gesture upward or outward, with an arm wearing the wearable device 100, for example, which may be repeated any number of times. The wearable device 100 may remain relatively static and/or stable relative to the user's body. An accelerometer of the wearable device 100 may detect the movement of the wearable device 100 due to the movement of the user's body or body part. In an example embodiment, the detected movement may have a detected acceleration above a threshold acceleration so that the wearable device 100 may distinguish an intended gesture input from ordinary movement performed during exercise, for example. In an example embodiment, the gesture input may be provided by rotating the wrist or arm wearing the wearable device 100. In an example embodiment, gesture input such as hand turning gestures may be recognized, such as by using a touch screen display(s) on the wearable device 100.

As another example, a hover input to the wearable device 100 may be made in addition to or instead of the gesture input.

In an example embodiment, such as any of the example embodiments provided above, the wearable device 100 may detect the gesture input and cause an associated indication of the gesture input to be provided to the wearable device control apparatus 202. In an example embodiment, the wearable device control apparatus 202 may interpret one type of gesture input as a selection of a currently previewed media file. In this example embodiment, the wearable device control apparatus 202 may interpret another type of gesture input to not select the currently previewed media file. In this instance, the wearable device control apparatus 202 may, instead, interpret the other type of gesture input to request another action, such as a request to haptically provide information regarding another data item, such as the next media file in the playlist.

Continuing to operation 420, the wearable device control apparatus 202 may include means, such as memory device 326, processor 320, and/or the like, for determining an operation to be performed on a user device based on the indication of the selected data item, such as the selected media item, e.g., the selected media file. For example, the wearable device control apparatus 202 may determine a default operation such as playing a currently previewed data item, such as the currently previewed media file.

In an example embodiment, indications of gesture inputs may be correlated to operations, such as stored on memory device 326. In this regard, different gesture input types may result in different kinds of operations being performed. In an example embodiment, indications of gesture inputs may be mapped to user controls or user interface components of the user device 210. As such, the wearable device control apparatus 202 may identify an operation based on an active application of the user device 210 and the gesture input.

In an example embodiment, a first type of gesture input may be distinguished from a second type of gesture input, and the operation to be performed is identified accordingly based on the type of gesture input. For example, a first type of gesture input, such as rotation of the wearable device 100, may indicate navigation and/or traversal of an options menu or other list of items, and may result in the wearable device 100 providing a preview of a media file with haptically provided information. A second type of gesture input, such as a pumping of the wrist, may indicate selection by the user of a currently previewed song and/or current menu item (e.g., a menu item associated with most recent haptically provided information). Therefore, an operation may be determined based on a type of gesture input.

As another example relating to different types of gesture input, a user may touch the wearable device 100. A preconfigured playlist, such as one stored on or accessed by the wearable device 100 may be selected and the songs may be previewed by rotating the wearable device 100. A user may then make a pumping gesture to remove a selected song from the playlist.

In an example embodiment, the operation may be determined based on an activity of the user. For example, the wearable device control apparatus 202 may be configured to control music playback when the user is jogging. As such, an indication of the activity may be provided by the user to the wearable device 100 and/or wearable device control apparatus 202. In an example embodiment, the wearable device control apparatus 202 may detect an activity of the user. The wearable device control apparatus may detect the activity of the user in various manners, such as by comparing predefined activity profiles associated with respective types of activities with readings provided by one or more sensors. For example, smoother movement and relatively high speeds may indicate the user is on a bicycle. The wearable device 100 may therefore be configured to detect gesture inputs based on different threshold accelerations and/or the like, to compensate for the user moving at a higher speed than when jogging, for example. In an example embodiment, the wearable device 100, wearable device control apparatus 202, and/or user device 210 may determine a default operation (e.g., begin playing music) to be performed upon detection of a user activity.

In general, various known feature extraction and pattern classification methods may be used for detecting the user activity. In one example, mel-frequency cepstral coefficients are extracted from the accelerometer signal magnitude, and a Bayesian classifier may be used to determine the most likely activity given the extracted feature vector sequence as an input. Gaussian mixture models may be used as the density models in the Bayesian classifier. The parameters of the Gaussian mixture models may be estimated using the expectation maximization algorithm and a set of collected training data from various activities. Such an approach has been described in Leppänen, Eronen, “Accelerometer-based activity recognition on a mobile phone using cepstral features and quantized GMMs”, in Proceedings of the 2013 IEEE International Conference on Acoustics, Speech and Signal Processing (ICASSP), pp. 3487-3491, Vancouver, Canada, 26-31 May 2013, which is hereby incorporated by reference in its entirety.

The wearable device control apparatus 202 may identify any of a variety of operations to be performed by the user device 210. For example, the wearable device control apparatus 202 may determine a desired operation to be selecting a menu item (e.g., song or workout program), playing a song or playlist, skipping to a next song, changing volume, pausing or restarting a song or playlist, previewing a next audio track, adding a song to a playlist, changing an order of songs on a playlist, and/or the like. In an example embodiment, the wearable device control apparatus 202 may control a workout device, in which case the determined operation may comprise changing a workout program, a workout mode, and/or the like.

In an example embodiment, the wearable device control apparatus 202 may determine the operation based on a direction of a movement as indicated by the indication of the gesture input. For example, a user traversing a song selection list by rotating the wearable device 100, may change directions of the rotation in order to move “back” in the song selection list (e.g., preview a previously previewed song).

In an example embodiment, the wearable device control apparatus 202 may determine the operation based on a force associated with the gesture input. For example, a user may touch or apply a gentle force to the wearable device control apparatus 202 to select a playlist. The user may then press harder to begin previewing the playlist.

Furthermore, in an example embodiment, the wearable device control apparatus 202 may be configured to identify a device, such as user device 210, on which the operation is to be performed. A user may therefore configure the wearable device 100 to be operative with various user devices 210, and the wearable device 100 may be configured to detect which user device 210 is within range to communicate via a WPAN, for example.

Following the determination of an operation to be performed with respect to operation 420, as shown by operation 430, the wearable device control apparatus 202 may include means, such as communication interface 324, user interface 322, processor 320, and/or the like, for causing the operation to be performed by the user device (e.g., user device 210 and/or wearable device 100). For example, causing the operation to be performed may comprise playing a next song, pausing playback, any other operation determined with respect to operation 420, and/or the like. As yet another example embodiment, a user may select recommended songs to be played next or added to a playlist. Instant play may be initiated by holding the pumping gesture at one end of the wrist for a specific amount of time, such as while haptic feedback is provided. Regular pumping action (back and forth) may cause a song to be added to the playlist, as a default action.

According to an example embodiment described above, a user may provide gesture input to a wearable device 100 in order to control functionality of a user device (the wearable device or other device in the user's procession), with haptically provided information to facilitate the gesture input and/or to provide feedback in response to the gesture input. A user working out or exercising may therefore operate a user device without having to look downward at a watch and/or without risking dropping and/or breaking a mobile device being carried. For example, a user device 210 may be carried in a back pocket of a user's clothing, or saddle bag of a bicycle, and may be used to control music playback as directed according to inputs made to the wearable device 100. Furthermore, haptically provided information provided by the wearable device may allow a user to preview song selections without disrupting a currently played audio track.

As described above, FIG. 4 illustrates a flowchart of a wearable device control apparatus 202, method, and computer program product according to an example embodiment of the invention. It will be understood that each block of the flowchart, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 326 of an apparatus 300 employing an example embodiment of the present invention and executed by a processor 320 of the apparatus 300. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

In an example embodiment, certain ones of the operations above may be modified or further amplified. Furthermore, in an example embodiment, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
causing information to be haptically provided via a wearable device so as to provide a preview of a data item;
receiving an indication of a selection of the data item provided via the wearable device;
with a processor, determining an operation to be performed on a user device based on the indication of the selected data item; and
causing the operation to be performed by the user device.

2. The method of claim 1, wherein the causing the information to be haptically provided comprises causing a vibration corresponding to content or a characteristic of the data item to be haptically provided.

3. The method of claim 1, wherein the indication of the selection of the data item is provided via a gesture input to the wearable device.

4. The method of claim 1, wherein the indication of the selection is provided based on a movement of the wearable device relative to the user's body.

5. The method of claim 1, wherein the operation to be performed by the user device is further based on an activity being performed by the user.

6. The method of claim 1, wherein the data item comprises a media file, and wherein the operation comprises initiating playing the selected media file.

7. The method of claim 1, wherein the operation to be performed by the user device is further based on a type of gesture input.

8. The method of claim 1, further comprising:
causing provision of another data item via the wearable device while the information is haptically provided, wherein the provision of the another data item is undisturbed.

9. An apparatus comprising at least one processor and at least one memory including computer program code, the at least one memory and the computer program code configured to, with the processor, cause the apparatus to at least perform:
causing information to be haptically provided via a wearable device so as to provide a preview of a data item;
receiving an indication of a selection of the data item provided via the wearable device;
determining an operation to be performed on a user device based on the indication of the selected data item; and
causing the operation to be performed by the user device.

10. The apparatus of claim 9, wherein the causing the information to be haptically provided comprises causing a vibration corresponding to content or a characteristic of the data item to be haptically provided.

11. The apparatus of claim 9, wherein the indication of the selection of the data item is provided via a gesture input to the wearable device.

12. The apparatus of claim 9, wherein the indication of the selection is provided based on a movement of the wearable device relative to the user's body.

13. The apparatus of claim 9, wherein the operation to be performed by the user device is further based on an activity being performed by the user.

14. The apparatus of claim 10, wherein the data item comprises a media file, and wherein the operation comprises initiating playing the selected media file.

15. The apparatus of claim 9, wherein the operation to be performed by the user device is further based on a type of gesture input.

16. The apparatus of claim 9, wherein the at least one memory and the computer program code are further configured to, with the processor, cause the apparatus to at least perform:
causing provision of another data item via the wearable device while the information is haptically provided, wherein the provision of the another data item is undisturbed.

17. A computer program product comprising at least one non-transitory computer-readable storage medium having computer-executable program code instructions stored therein, the computer-executable program code instructions comprising program code instructions for:
causing information to be haptically provided via a wearable device so as to provide a preview of a data item;
receiving an indication of a selection of the data item provided via the wearable device;
determining an operation to be performed on a user device based on the indication of the selected data item; and
causing the operation to be performed by the user device.

18. The computer program product of claim 17, wherein the causing the information to be haptically provided comprises causing a vibration corresponding to content or a characteristic of the data item to be haptically provided.

19. The computer program product of claim 17, wherein the indication of the selection of the data item is provided via a gesture input to the wearable device.

20. The computer program product of claim 9, wherein the indication of the selection is provided based on a movement of the wearable device relative to the user's body.
